(19) United States
(12) Patent Application Publication
(10) Pub. No.: US 2010/0126347 A1
(43) Pub. Date: May 27, 2010

(54) PROCESS FOR THE REMOVAL OF CARBON DIOXIDE FROM GAS STREAMS

(76) Inventors: Anthony Dwight Maunder, Berkshire (GB); Geoffrey Frederick Skinner, Berkshire (GB)

Correspondence Address: NIXON & VANDERHYE, PC, 901 NORTH GLEBE ROAD, 11TH FLOOR, ARLINGTON, VA, 22203, US

(21) Appl. No.: 12/451,421

(22) PCT Filed: May 16, 2008
(86) PCT No.: PCT/GB2008/001698

§ 371 Date: Nov. 12, 2009

(30) Foreign Application Priority Data
May 16, 2007 (GB) 0709433.7

(51) Int. Cl. C10L 3/10; B01D 53/14

(52) U.S. Cl. 95/174

(57) ABSTRACT

A process for the removal and recovery of carbon dioxide from a gaseous stream, in particular the removal and recovery of carbon dioxide, and optionally hydrogen sulphide, from a natural and/or synthesis gas stream. Furthermore, the present invention provides for the release of the removed and recovered carbon dioxide, and optionally hydrogen sulphide, at an elevated pressure, thereby reducing the high carbon dioxide compression costs associated with further chemical processing e.g. for under-ground carbon sequestration and/or for subsurface enhanced hydrocarbon recovery and/or for the manufacture of urea.

The present invention provides a process for the removal and recovery of carbon dioxide from a gaseous stream, in particular the removal and recovery of carbon dioxide and optionally hydrogen sulphide from a natural and/or synthesis gas stream. Furthermore, the present invention provides for the release of the removed and recovered carbon dioxide and optional hydrogen sulphide at an elevated pressure, thereby reducing the high carbon dioxide compression costs associated with underground carbon sequestration and/or for subsurface enhanced hydrocarbon recovery and/or further chemical processing e.g. for the manufacture of urea.

The removal and recovery of acid gases (also known as scrubbing), particularly the removal and recovery of carbon dioxide, from gas streams such as natural and synthesis gas streams has been practiced for many years. Generally the removal of carbon dioxide is commonly practiced by washing the incoming gas with solvents such as aqueous solutions of amines, aqueous solutions of potassium carbonate, or by using an organic solvent such as the proprietary “Selexol” solvent or methanol and/or other alcohols. In particular the most common solvents used are cold methanol e.g. the RECTISOL process, and hot potassium carbonate e.g. the BENFIELD process. Recovery of the dissolved carbon dioxide from the solution is generally achieved by depressurisation of the carbon dioxide rich solvent to near atmospheric pressure (generally between 1 and 2 bar), supplemented, as required, by stripping the solvent of dissolved carbon dioxide with vapour generated by the evaporation of the solvent in a reboiler or, less usually, with a gas such as nitrogen. Examples of different methods of acid gas scrubbing can be found in the following documents:

EP1543874 discloses a method of making a product gas mixture providing a first gas mixture, contacting the first gas mixture with a lean absorber liquid at a first pressure and absorbing a portion of the first gas mixture in the lean absorber liquid to provide a rich absorber liquid and a non-absorbed residual gas, pressurizing the rich absorber liquid, stripping the pressurized rich absorber liquid with a stripping gas at a second pressure greater than the first pressure to provide a pressurized lean absorber liquid and the product gas mixture, and reducing the pressure of the pressurized lean absorber liquid to provide the lean absorber liquid at the first pressure. The first gas mixture may be a synthesis gas comprising hydrogen and carbon dioxide.

US2003000698 describes a process for pretreating a natural gas under pressure containing hydrocarbons, acid compounds such as hydrogen sulfide and carbon dioxide, and water. The natural gas is cooled to condense part of the water. The partially dehydrated natural gas is then contacted with a liquid stream consisting of a majority of hydrogen in two successive contact zones so as to obtain a natural gas containing substantially no water any more. Finally, this dehydrated natural gas is cooled to condense and separate the acid compounds, this cooling stage being carried out by means of a heat exchanger, an expander or a venturi neck.

U.S. Pat. No. 4,515,604 describes a process for producing a synthesis gas which has a low inert gas content and is intended for the synthesis of alcohols, particularly of methanol, and of hydrocarbons, and which is produced from coal or heavy hydrocarbons, by a gasification under pressure with oxygen and steam, whereafter the raw gas is cooled, the impurities are removed by a scrubbing with methanol, and the methanol is removed by means of molecular sieves from the cold pure gas. The pure gas is then cooled further and partly liquefied, the remaining gas is further cooled by a pressure relief and methane is distilled from the liquid part with simultaneous recovery of the synthesis gas, which consists of hydrogen and carbon monoxide and has a low methane content. All or part of the methane is compressed and is subsequently reacted with steam and oxygen to produce carbon monoxide and hydrogen. The produced gas is admixed to the synthesis gas or to the partly purified raw gas.

EP0768365 relates to a process for removing highly concentrated CO2 from high-pressure natural gas and recovering it in a high-pressure state. This process comprises the absorption step of bringing high-pressure natural gas having a CO2 partial pressure of 2 kg/cm2 or greater and a pressure of 30 kg/cm2 or greater into gas-liquid contact with a regenerated CO2-lean absorbing fluid comprising a CO2 absorbing fluid of which the difference in saturated CO2 absorption level between 40 DEG C and 120 DEG C is not less than 30 Nm3 per ton of solvent at a CO2 partial pressure of 2 kg/cm2, whereby highly concentrated CO2 present in the high-pressure natural gas is absorbed into the CO2-lean absorbing fluid to produce refined natural gas having a reduced CO2 content and a CO2-rich absorbing fluid; and the regeneration step of heating the CO2-rich absorbing fluid without depressurizing it, whereby high-pressure CO2 having a pressure of 10 kg/cm2 or greater is liberated and a CO2-lean absorbing fluid is regenerated and recycled for use in the absorption step. Specific examples of the aforesaid absorbing fluid include an aqueous solution of N-methyldiethanolamine (MDEA), an aqueous solution of triethanolamine, and an aqueous solution of potassium carbonate, as well as these solutions having a CO2 absorption promoter (e.g., piperazine) added thereto.

WO200603732 relates to a method for the recovery of carbon dioxide from a gas and uses thereof. More particularly, WO200603732 relates to a two-step method for recovery of carbon dioxide by condensation (B) at a temperature close to but above the triple point of carbon dioxide and a subsequent absorption (D) of the gaseous carbon dioxide, which is not liquefied during condensation. WO200603732 also relates to a plant for the recovery of carbon dioxide from a gas.

In the past, the recovered carbon dioxide has often been discharged from the scrubbing process at close to atmospheric pressure. Generally the removed carbon dioxide has been discharged to the atmosphere as a waste stream and so there has been little incentive to recover it at an elevated pressure.

However, it is now known that some industrial processes require that the carbon dioxide removed is delivered at elevated pressures (e.g. in excess of 50 or even 100 bar). The most important examples of these said industrial processes are the sequestration of carbon dioxide in underground strata, which is typically in excess of 100 bar; the use of carbon dioxide in subsurface enhanced hydrocarbon recovery and/or some chemical process e.g. the use of carbon dioxide for the manufacture of urea.

Sequestration of the carbon dioxide (particularly the carbon dioxide that is produced during the combustion of fossil fuels) in the underground strata is now of a greater interest than ever due to the well documented environmental concern associated with the level of carbon dioxide in today's atmosphere; especially since carbon dioxide is considered to be the most prominent of all the so-called “greenhouse gases”. Hence, it is becoming increasingly desirable and necessary to minimise atmospheric emissions of the said greenhouse gases in order to reduce the harm they have on the global climate.

Therefore, it is often proposed to compress the said carbon dioxide, that is removed and recovered, to a very high pressure (typically over 100 bar) and then to store it deep within the underground strata (i.e. carbon dioxide sequestration) and/or for use in subsurface enhanced hydrocarbon recovery and/or for some chemical process e.g. the manufacture of urea. However, if the carbon dioxide is recovered from the combustion processes by conventional scrubbing i.e. with the recovered carbon dioxide being released from the scrubbing process at near atmospheric pressure (as described above), then the energy and the capital costs are obviously very large for the compression needed in order to reach the required pressures.

Thus, according to the present invention, the applicants have unexpectedly found that by operating under a specific sequence and combination of temperature, pressure and solvent, it is possible to recover carbon dioxide from a gaseous steam (i.e. a carbon dioxide scrubbing process) at an elevated pressure, thereby considerably reducing the energy and capital costs associated with compressing carbon dioxide to the high pressures required for some industrial processes.

Furthermore, the present invention provides a process for the removal and recovery of carbon dioxide, and optionally hydrogen sulphide, from a gaseous stream, in particular the removal and recovery of carbon dioxide, and optionally hydrogen sulphide, from a natural and/or synthesis gas stream; at an elevated pressure. It also provides for the release of the removed and recovered carbon dioxide at said elevated pressure, thereby reducing the high carbon dioxide compression costs associated with:
underground carbon sequestration so as to abate global warming; and/or
subsurface enhanced hydrocarbon recovery; and/or
chemical process e.g. the manufacture of urea.

Thus, the present invention provides a method of removing and recovering carbon dioxide from a gaseous feed stream characterized by the following consecutive steps:
(i) providing the gaseous stream at a temperature of between 20 to −100° C. and at a pressure of between 10 to 150 bar; and
(ii) contacting said gaseous stream with a carbon dioxide solvent to produce at least two streams, one being a purified gaseous stream, having less than 5 mol % carbon dioxide, and one being a solvent stream rich in carbon dioxide; and
(iii) treating said solvent stream rich in carbon dioxide at a pressure of from 5 to 100 bar and at a temperature in the range 100 to 220° C. in a solvent regeneration unit, to separate and recover respectively a carbon dioxide stream and a liquid solvent stream, at high pressure; and
(iv) recovering the purified gaseous stream comprising less than 5 mol % of carbon dioxide from step (ii) at high pressure.

The gaseous stream used according to the present invention, is preferably a natural gas or a synthesis gas stream, said stream containing optionally hydrogen sulphide. Synthesis gas (also known as “syngas”) refers to a combination of hydrogen and carbon oxides produced in a synthesis gas plant from a carbon source such as natural gas, petroleum liquids, biomass and carbonaceous materials including coal, recycled plastics, municipal wastes, or any organic material.

The gaseous stream preferably comprises between 5 and 50 mol % of carbon dioxide. Gaseous feeds comprising carbon monoxide and hydrogen, e.g. synthesis gas may undergo purification prior to being fed into any of the reaction zones. Synthesis gas purification may be carried out by processes known in the art. See, for example, Weissermel, K. and Arpe H.-J., Industrial Organic Chemistry, Second, Revised and Extended Edition, 1993, pp. 19-21.

Furthermore, the applicants have unexpectedly found that the present invention can also be used for the combined recovery of carbon dioxide and hydrogen sulphide, which is particularly useful e.g. for the carbon dioxide recovery from a coal gasification plant gas.

According to the present invention, the gaseous feed stream is provided at a temperature of less than 20° C., preferably less than −10° C. and most preferably less than −20° C. According to the present invention, the gaseous feed stream is provided at a temperature of more than −100° C., preferably at more than −70° C. and most preferably at more than −50° C. Similarly the stream is also provided at a pressure of between 10 to 150 bar and preferably at a pressure between 20 to 80 bar. The temperature and pressure of the gaseous feed stream is preferably adjusted by passing the stream through any suitable heat transfer unit (e.g. a heat exchange unit) and/or compression unit. Obviously, if the gaseous feed stream is already provided to an operator at the pre-required temperature and pressure then there is no need to further condition the gaseous feed stream.

Thus according to the present invention, the gaseous feed stream is then contacted with a carbon dioxide solvent to produce at least two streams, one being a purified gaseous stream having less than 5 mol % carbon dioxide, preferably less than 2 mol %, and one being a solvent stream rich in carbon dioxide. Said contacting procedure can be performed in any appropriate vessel known to those skilled in the art e.g. a carbon dioxide absorption column.

The carbon dioxide absorption unit is preferably operated such that it minimises any pressure loss during operation e.g. the carbon dioxide absorption unit is operated so that it has less than 10% pressure loss overall.

According to the present invention, the carbon dioxide solvent employed is preferably any carbon dioxide solvent that has a boiling point of between 50 and 150° C. at atmospheric pressure and is preferably an oxygenated organic compound, with methanol being the most preferred solvent. Methanol's higher volatility relative to that of aqueous solvents facilitates operation of the reboiler at the aforesaid elevated pressures at lower reboiler liquid temperatures (in the range of 200° C.) than would be necessary with the said aqueous solvents. Moreover methanol is not normally subject to degradation in such a temperature, unlike other solvents known to those skilled in the art. As indicated hereinabove, the carbon dioxide solvent used in the present invention is also particularly useful for the combined recovery of carbon dioxide and hydrogen sulphide, which is a particular embodiment according to the present invention e.g. for the carbon dioxide recovery from a coal gasification plant gas.

Preferably the temperature of the carbon dioxide solvent introduced into the carbon dioxide absorption unit is conditioned to a temperature of less than 20° C., preferably less than −10° C. and most preferably less than −20° C.; and more than −100° C., preferably more than −70° C. and most preferably more than −50° C. Similarly the pressure of the carbon dioxide solvent introduced into the carbon dioxide absorption unit is between 10 to 150 bar and is preferably between 20 to 80 bar.

According to an embodiment of the present invention, the temperature of the gaseous feed stream is always higher than the temperature of the carbon dioxide solvent introduced into the carbon dioxide absorption unit, preferably the temperature of the gaseous feed stream is 10° C., more preferably 15° C., higher than the temperature of the carbon dioxide solvent introduced into the carbon dioxide absorption unit.

According to a preferred embodiment of the present invention, the pressure of the gaseous feed stream is always similar to that of the carbon dioxide solvent introduced into the carbon dioxide absorption unit.

The purified gaseous stream exiting the carbon dioxide absorption unit comprises less than 5 mol % of carbon dioxide, preferably less than 2 mol % and most preferably less than 0.5 mol %; and is recovered at high pressure e.g. a pressure that is substantially similar to the operating pressure of the carbon dioxide absorption unit. This purified gaseous stream is then preferably subjected to a re-heating stage in order to aid efficient energy recovery.

According to an embodiment of the present invention, the temperature adjustment of the said purified gaseous stream is conducted in the same heat transfer unit as the initial temperature adjustment of the gaseous feed stream and/or the carbon dioxide solvent conditioning unit (mentioned hereinabove), which results in a very efficient mode of operation.

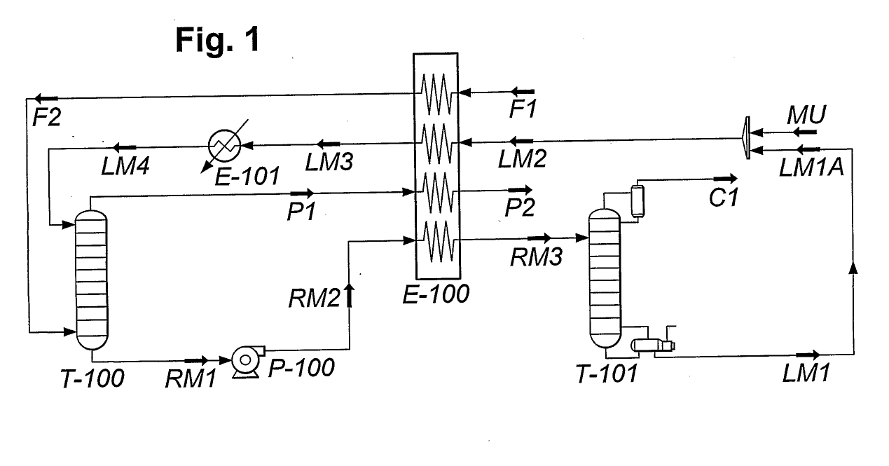

The solvent stream rich in carbon dioxide, exiting the carbon dioxide absorption unit, is then treated at a pressure of from 5 to 100 bar and at a temperature in the range 100 to 220° C. in a solvent regeneration unit. Optionally (as depicted in FIG. 1), prior to its introduction into the solvent regeneration unit, the pressure of said solvent stream rich in carbon dioxide is increased by at least 1 bar, preferably by at least 2 bars. Preferably, prior to its introduction into the solvent regeneration unit, the temperature of said solvent stream rich in carbon dioxide is increased to at least 100° C., but not more than 220° C.

According to an embodiment of the present invention, the temperature adjustment of the said solvent stream rich in carbon dioxide is conducted in the same heat transfer unit as the initial temperature adjustment of the gaseous feed stream and/or the carbon dioxide solvent conditioning unit (mentioned hereinabove) and/or of the purified gaseous stream; which results in a very efficient mode of operation.

As indicated previously, the solvent stream, rich in carbon dioxide, is treated at a pressure of from 5 to 100 bar and at a temperature of between 100 to 220° C. in a solvent regeneration unit, to separate:

(a) a gaseous carbon dioxide stream; and

(b) a liquid solvent stream.

Said solvent regeneration treatment is preferably performed in any appropriate solvent regeneration unit, e.g. a column containing packing or trays (also known to the man skilled in the art as a ‘stripper’ column).

The separated gaseous carbon dioxide stream (i.e. stream (a)) may still comprise solvent vapour. Therefore according to a preferred embodiment said gaseous carbon dioxide stream is subsequently cooled to further condense the solvent in order to yield a purified carbon dioxide stream, at a high pressure e.g. 5 to 100 bar. Said operation can be performed, for example, using an overhead condenser as depicted in FIG. 1. Alternatively, this operation may also be performed as part of integrated process within the said solvent regeneration unit.

According to a preferred embodiment of the present invention, the recovered carbon dioxide stream is subjected to a further cooling stage in order to condense any remaining solvent. The temperature of the recovered carbon dioxide stream may be as low as −40° C.

Operation at this elevated regeneration pressure naturally increases the temperature range of the solvent in the reboiler. It also requires that the solvent (e.g. methanol) is thermally stable in said higher temperature range.

The recovered high pressure carbon dioxide stream (e.g. at a pressure of at least 10 bar), according to the present invention, may be then be optimised for carbon dioxide sequestration in the underground strata and/or for subsurface enhanced hydrocarbon recovery and/or for the manufacture of urea.

Said liquid regenerated solvent stream (indicated as stream (b) above) can then be recycled as at least a part, preferably all, of said carbon dioxide solvent stream (mentioned hereinabove) used in the carbon dioxide absorption unit. Obviously, then the said liquid regenerated solvent stream is subjected to the aforementioned temperature solvent conditioning.

A particular example is illustrated on the attached flow diagram (FIG. 1) and the corresponding principal material flows, pressures and temperatures are shown on the attached table.

Thus, FIG. 1 represents an embodiment of a process scheme according to the present invention, wherein the references correspond to those used below.

The feed gas Stream F1 having a CO2 content of 16 mol % enters the CO2 removal unit at 41.5 bar/+30° C. It is cooled to −25° C. in heat exchanger E-100 before entering the CO2 absorber T-100 as Stream F2. In T-100 the gas is washed with methanol, which reduces its CO2 content to 1.7 mol % at the outlet. The absorber outlet gas Stream P1 is reheated in E-100 and leaves the CO2 removal unit at 39.5 bar/+40° C.

The pressure of the CO2-rich methanol Stream RM1 leaving the bottom of T-100 at 41.0 bar/−28.4° C. is raised to 45.5 bar by pump P-100, leaving as Stream RM2. This stream is heated to +168.5° C. in heat exchanger E-100, emerging as Stream RM3 before entering stripper T-101.

In this column the CO2-rich methanol is stripped with methanol vapour generated by an externally heated reboiler. The overhead CO2 stream, after cooling to condense most of its methanol content, flows to the plant limits as Stream C1.

The lean methanol leaving the base of T-101 as Stream LM1 at 41 bar/+205° C. is cooled successively in heat exchanger E-100 and refrigerated chiller E-101 before returning to T-100 at 40 bar/−40° C. as Stream LM4.

A small stream of methanol (Stream MU) is admitted to the circulating solvent flow, in order to compensate for methanol loss in the product gas (Stream P2) and in the recovered CO2 (Stream C1).

| | |
|---|---|
| Process for Removal of Carbon Dioxide from Gases | Table of figs for 1/1 |
| Gasconsult Limited | |
| GCL01/2007 | |
| May-07 | |

| STREAM | | C1 | F1 | F2 | LM1 | LM2 | LM3 | LM4 |
|---|---|---|---|---|---|---|---|---|
| Vapour Fraction | | 1 | 1 | 1 | 0 | 0 | 0 | 0 |
| Temperature (° C.) | | 79.48 | 30 | −25 | 204.9 | 205 | −30 | −40 |
| Pressure (bar absolute) | | 40 | 41.5 | 41 | 41 | 41 | 40.5 | 40 |
| Flowrate (kgmole/h) | H₂ | 2.3 | 840 | 840 | 0 | 0 | 0 | 0 |
| | CO₂ | 289.7 | 320 | 320 | 0.9 | 0.5 | 0.5 | 0.5 |
| | N₂ | 15.9 | 800 | 800 | 0 | 0 | 0 | 0 |
| | CH₄ | 2.3 | 40 | 40 | 0 | 0 | 0 | 0 |
| | methanol | 19.7 | 0 | 0 | 1779.6 | 1799.5 | 1799.5 | 1799.5 |
| | total | 330 | 2000 | 2000 | 1780.6 | 1800 | 1800 | 1800 |
| Total Mass Flow (kg/h) | | 13870.8 | 38828.7 | 38828.7 | 57063.5 | 57681.6 | 57681.6 | 57681.6 |

| STREAM | | LM1A | MU | P1 | P2 | RM1 | RM2 | RM3 |
|---|---|---|---|---|---|---|---|---|
| Vapour Fraction | | 0 | 0 | 1 | 1 | 0 | 0 | 0.1858 |
| Temperature (° C.) | | 205 | 206.3 | −40.46 | 40 | −28.4 | −28.32 | 168.5 |
| Pressure (bar absolute) | | 41 | 45 | 40 | 39.5 | 41 | 45.5 | 45 |
| Flowrate (kgmole/h) | H₂ | 0 | 0 | 837.7 | 837.7 | 2.3 | 2.3 | 2.3 |
| | CO₂ | 0.5 | 0 | 29.9 | 29.9 | 290.6 | 290.6 | 290.6 |
| | N₂ | 0 | 0 | 784.1 | 784.1 | 15.9 | 15.9 | 15.9 |
| | CH₄ | 0 | 0 | 37.7 | 37.7 | 2.3 | 2.3 | 2.3 |
| | methanol | 1780 | 19.5 | 0.1 | 0.1 | 1799.4 | 1799.4 | 1799.4 |
| | total | 1780.5 | 19.5 | 1689.4 | 1689.4 | 2110.6 | 2110.6 | 2110.6 |
| Total Mass Flow (kg/h) | | 57058 | 623.8 | 25575.9 | 25575.9 | 70934.4 | 70934.4 | 70934.4 |

1-16. (canceled)

17. A method of removing and recovering carbon dioxide from a gaseous stream characterized by the following consecutive steps:
(i) providing the gaseous feed stream at a temperature of between 20 to −100° C. and at a pressure of between 10 to 150 bar; and
(ii) contacting said gaseous stream with a methanol stream that is at a temperature of between 20 to −100° C. to produce at least two streams, one being a purified gaseous stream, having less than 5 mol % carbon dioxide, and one being a methanol stream rich in carbon dioxide; and
(iii) treating said methanol steam rich in carbon dioxide at a pressure of from 5 to 100 bar and at a temperature in the range 100 to 220° C. in a solvent regeneration unit, to separate and recover respectively a carbon dioxide stream and a liquid methanol stream, at high pressure; and
(iv) recovering the purified gaseous stream comprising less than 5 mol % of carbon dioxide from step (ii) at high pressure.

18. A method according to claim 17, wherein the gaseous stream is any of the following natural gas, synthesis gas and synthesis gas containing hydrogen sulphide; and any combinations thereof.

19. A method according to claim 17, wherein the gaseous feed steam comprises between 5 and 50 mol % of carbon dioxide.

20. A method according to claim 17, wherein the gaseous feed stream is provided at a temperature of less than −10° C. and preferably at a temperature of less than −20° C.; and at a temperature of more than −70° C. and preferably at a temperature more than −50° C.

21. A method according to claim 17, wherein the gaseous feed stream is provided at a pressure of between 20 to 80 bar.

22. A method according to claim 17, wherein the temperature of the methanol introduced into the carbon dioxide absorption unit is less than −10° C. and preferably less than −20° C.; and more than −70° C. and preferably more than −50° C.

23. A method according to claim 17, wherein the pressure of the methanol introduced into the carbon dioxide absorption unit is between 10 to 150 bar and is preferably at a pressure of between 20 to 80 bar.

24. A method according to claim 17, wherein the temperature of the gaseous feed stream is always higher than the temperature of the methanol introduced into the carbon dioxide absorption unit, preferably the temperature of the gaseous feed stream is 10° C., more preferably 15° C., higher than the temperature of the methanol introduced into the carbon dioxide absorption unit.

25. A method according to claim 17, wherein the purified gaseous stream exiting the carbon dioxide absorption unit comprises less thin 2 mol % and most preferably less than 0.5 mol % of carbon dioxide.

26. A method according to claim 17, wherein the separated carbon dioxide gaseous stream (from step (iii) of claim 17), is subjected to one of more cooling stages in order to condense the methanol and to yield a purified carbon dioxide stream, which is at a high pressure e.g. 5 to 100 bar.

27. A method according to claim 17, wherein the high pressure carbon dioxide stream is used for carbon dioxide sequestration and/or for subsurface enhanced hydrocarbon recovery and/or for chemical processing e.g. for the manufacture of urea.

28. A method according to claim 17, wherein the process is used for the combined recovery of carbon dioxide and hydrogen sulphide e.g. for use on a coal gasification plant.

29. A method according to claim 17, wherein the liquid regenerated methanol stream (from step (iii) of claim 17), is recycled to form the methanol, stream (of step (ii) of claim 17) used in the carbon dioxide absorption unit.

30. A method according to claim 17, wherein the pressure of the methanol stream rich in carbon dioxide of step (ii) of claim 17 is increased by at least 1 bar, preferably by at least 2 bars prior to being introduced into the solvent regeneration unit of step (iii) of claim 17.
